(19) United States
(12) Patent Application Publication
(10) Pub. No.: US 2022/0168895 A1
(43) Pub. Date: Jun. 2, 2022

(54) COLLISION DETECTION

(71) Applicant: GENESIS ROBOTICS AND MOTION TECHNOLOGIES, LP, WICHITA, KS (US)

(72) Inventor: David LOKHORST, Victoria (CA)

(73) Assignee: GENESIS ROBOTICS AND MOTION TECHNOLOGIES, LP, WICHITA, KS (US)

(21) Appl. No.: 17/437,436

(22) PCT Filed: Mar. 26, 2020
(86) PCT No.: PCT/IB2020/052869

§ 371 Date: Sep. 9, 2021

Related U.S. Application Data
(60) Provisional application No. 62/825,515, filed on Mar. 28, 2019.

(51) Int. Cl. B25J 9/16; G05B 19/4155

(52) U.S. Cl. CPC B25J 9/1674; G05B 2219/40269; G05B 19/4155

(57) ABSTRACT

A method of monitoring movement of a robotic arm, the robotic arm being arranged to be moved by an actuator, the method comprising: determining an expected robotic arm condition based on a known robotic condition and a torque applied to the robotic arm by the actuator; measuring an actual robotic arm condition during movement of the arm caused by the applied torque; and determining whether a collision has occurred by comparing the actual robotic arm condition with the expected robotic arm condition and generating a collision signal if a difference between the actual robotic arm condition and the expected robotic arm condition exceeds a threshold.

### CROSS REFERENCE TO RELATED APPLICATIONS

This application is based on U.S. Provisional Patent Application No. 62/825,515, filed Mar. 28, 2019. The priority of the foregoing application is hereby claimed, and the disclosure incorporated herein by reference in its entirety.

### FIELD OF THE INVENTION

This invention relates to a method of monitoring movement of a robotic arm and a robotic arm arranged to carry out the method.

### BACKGROUND

It is known that robots and humans may work in close proximity and, during such work, robots may cause injury to humans, in particular when colliding with humans.

One existing way to address this issue is to reduce the speed of movement of the robotic arm. However, this has an undesirable drawback of reducing efficiency of the robotic arm and slowing the process that the robotic arm is intended to perform.

An alternative way to address the issue is to use torque sensors, which may detect a torque resulting from an external force applied to the robotic arm and may thereby determine whether a collision has occurred. However, torque sensors can be expensive and heavy, thereby increasing the cost of the robotic arm and also increasing the weight of the robotic arm, which may result in more forceful collisions and a higher risk of injury.

The present inventor has sought to provide a means for detecting a collision with a robotic arm while avoiding some of the above problems.

### SUMMARY

According to a first aspect of the present invention, there is provided a method of monitoring movement of a robotic arm, the robotic arm being arranged to be moved by an actuator, the method comprising determining an expected robotic arm condition based on a known robotic condition and a torque applied to the robotic arm by the actuator; measuring an actual robotic arm condition during movement of the arm caused by the applied torque; and determining whether a collision has occurred by comparing the actual robotic arm condition with the expected robotic arm condition and generating a collision signal if a difference between the actual robotic arm condition and the expected robotic arm condition exceeds a threshold.

With such a method, a collision may be detected using means other than a torque sensor, such as an encoder or an imaging device, thereby providing a safer and more reliable way to determine whether a collision has occurred.

The overall reliability of the robotic arm may be improved with this invention because there is a net reduction in the number of complex parts in the robotic arm. In particular, torque sensors at each joint may not be necessary, and may be replaced with a more simple system that makes the comparison.

The comparing may be carried out by a comparison module. The comparison module may be separate from a control module used to drive the arm. The comparison module may be of limited functionality, such that the comparing may be the only function that the comparison module is able to carry out.

The comparison module may be a hardware module. This is contrast with software modules, which may be reprogrammable. The hardware module may be non-reprogrammable. An example of a hardware module may comprise op amps and transistors and may have no memory. The hardware module may also be a purely analogue device. The hardware module may also comprise an application specific integrated circuit (ASIC). The hardware module may also comprise a field programmable gate array (FPGA). By comparison to software modules, hardware modules may be less susceptible to interferences or bugs and may therefore be more reliable and robust. This may improve the overall safety of a robotic arm by avoiding the use of software within the collision detection scheme.

In particular, the comparison module is a separate device from a motion controller, which may comprise software. Therefore, the complex path planning computation can be carried out by a software module and the simpler, and more safety-critical, collision detection can be carried out by a hardware module.

Generally, the motion controller and the comparison module may be separate modules.

The method may further comprise stopping motion of the robotic arm based on the collision signal. Stopping of the motion may prevent injury to a human worker or damage to an object with which the arm is colliding.

The stopping may comprise activating a brake. Activating a brake may improve the rate of stopping and may thereby further reduce injury or damage.

The robotic arm condition may comprise at least one of: a position of the robotic arm, a velocity of the robotic arm, and an acceleration of the robotic arm. Since these values are relatively easy to measure, and can be reliably measured, this may improve the reliability of the method.

The position, velocity and/or acceleration may be angular position, angular velocity and/or angular acceleration respectively.

The expected robotic arm condition may change over time and may be output by a motion controller.

The measuring may be performed by an encoder assembly on the robotic arm. Encoder assemblies are reliable ways to determine angular movement and therefore the reliability of the method may be improved.

There are other means of measuring the robotic arm condition. For example, an analogue device such as a potentiometer may be used. In another example, a resolver could be used. In this description, the word “encoder” should be taken to mean a device mounted on the robotic arm that measures the deflection (angular or prismatic) of the joint to which it is mounted.

The encoder assembly may comprise two encoders arranged to output data to an encoder comparator and the encoder comparator may be arranged to determine a difference between the outputs of the encoders. The encoder comparator and the encoders may form a unitary encoder assembly. This may further improve the reliability of the method as a difference between the two encoder signals may indicate a failure of the encoder assembly, and may also satisfy various safety regulations.

The method may further comprise picking up a load with the robotic arm and the threshold may be based at least partially on the mass of the load. This may allow the method to be used within a pick and place functionality and may reduce the chances of a false collision signal being generated due to the mass of the load.

The method may further comprise modifying the threshold subsequently to picking up of the load. This may allow more accurate collision determination to be made before and after the picking up of the load.

The method may further comprise estimating the torque based on an electrical current input to the actuator. Estimating the torque based on the current input may provide a more simple way to estimate the torque, without requiring a dedicated torque measurement device.

The applied torque may be less than 80% of the maximum torque of the actuator. By avoiding approaching the maximum torque which the actuator can output, the estimated torque may be more easily predicted and the method may be made more reliable.

The method may further comprise calculating a Fourier transform of the applied torque before the movement of the robotic arm and selecting the applied torque based on the Fourier transform. By using a Fourier transform, undesirable frequency components of the applied torque may be detected and so the applied torque may be adjusted as necessary.

A rate of change of the applied torque may be within the bandwidth of the actuator. By avoiding changes in the applied torque outside the bandwidth of the actuator, the movement of the arm may be more predictable as the actuator may be more able to respond as required.

A highest frequency component of the applied torque may have a lower frequency than the lowest resonant frequency of a robotic arm. By avoiding inputting high-frequency components of the applied torque, resonance in the robotic arm, which may be misinterpreted by a comparator as a collision, can be avoided.

The robotic arm may comprise a plurality of joints, each joint having at least one actuator, and the measuring may comprise measuring a relative position and/or a relative velocity for each joint. Relative positions, relative velocities and/or relative accelerations may be more easily measured as they can be measured by devices situated within the joints without an external reference frame. By measuring these values at each joint, collisions at any part of a robotic arm may be more easily measured.

The determining of the expected robotic arm condition may be based at least partially on estimated robotic arm kinetic parameters, and the method may further comprise estimating the robotic arm kinetic parameters based on an actual robotic arm condition measured during movement of the robotic arm by the actuator. The robotic arm kinetic parameters may comprise: moments of inertia of the arm, the mass of the arm and/or the location of the centre of gravity of the arm. These parameters may be of the robotic arm as a whole or may be of each individual member of the arm and may be determined either by analysing the design of the arm or by measuring movement of the arm with known or estimated torques. The kinetic parameters may be iteratively refined within a learning algorithm.

According to a second aspect of the invention, there is provided a robotic arm comprising: a first member, a second member movably coupled to the first member, an actuator arranged to move the first member relative to the second member, a measuring device for determining a condition of the first and/or second member, and a controller coupled to the actuator and measuring device the controller being arranged to carry out the method according to the first aspect.

The controller may comprise: a motion controller arranged to determine the expected robotic arm condition; and a separate comparison module arranged to compare the expected robotic arm condition to the measured robotic arm condition. By separating the controller into a motion controller and a separate comparison module, the comparison module, which is the part crucial for detecting a collision, may be made more reliable.

The robotic arm may further comprise a brake, arranged to prevent movement of the first and special second member selectively, and the separate comparison module may be arranged to drive the brake directly. This may provide a more simple means for stopping the robotic arm following the determination that a collision has occurred.

### BRIEF DESCRIPTION OF THE DRAWINGS

FIG. 1 shows a robotic arm, according to an aspect of the invention;

FIG. 2 shows a control system according to an aspect of the invention;

FIG. 3 is a flowchart illustrating a method according to the invention; and

FIG. 4 is a flowchart illustrating a method of designing a motion path, according to the invention.

### DETAILED DESCRIPTION

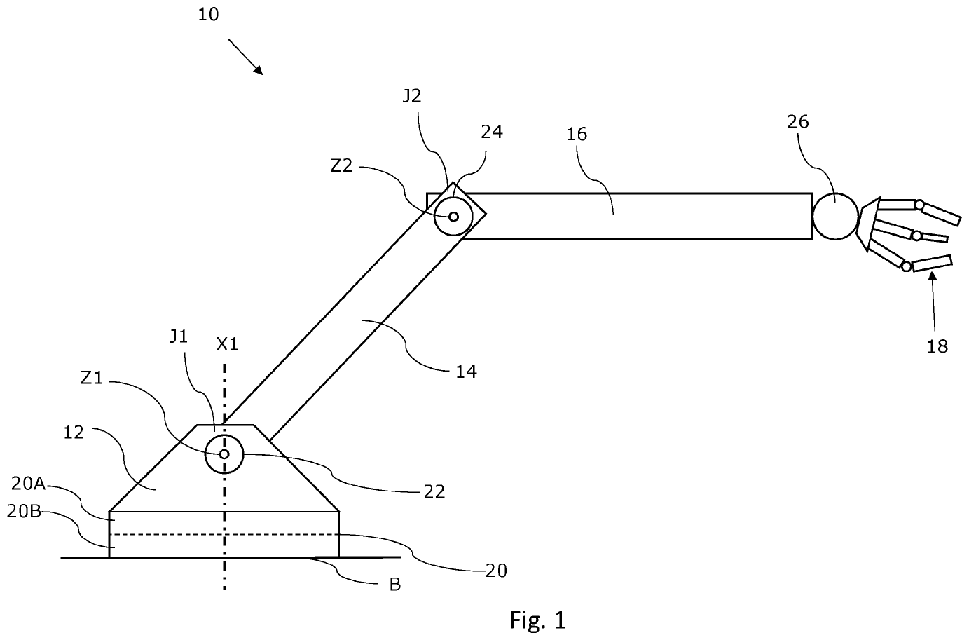

FIG. 1 shows a robotic arm 10. The robotic arm 10 comprises a base member 12, which is attached to an external base B. The base B may be the ground or may be a moving platform.

The base member 12 is coupled to the base B via an actuator 20, which is arranged to rotate the base member 12 relative to the base B about a vertical axis Xl.

The actuator 20 has two parts, a base actuator 20a, arranged to move the base member 12, which may be an electric motor, optionally a radial or axial flux motor, and which may include a gearbox, and a brake 20b arranged to selectively prevent rotation of the base member 12, and thereby of the robotic arm 10, relative to the base B. While the base actuator 20a and brake 20b are shown as being separate, it will be understood that the brake 20b may be inside the actuator 20a on coupled in parallel to the base actuator 20a.

The base member 12 is coupled to a first member 14, which may also be considered as an upper arm member 14, at a first joint J1, which may be considered as a shoulder joint. The first member 14 is movable relative to the base member 12 about a horizontal axis Z1 and a first actuator 22 is arranged to rotate the first member 14 relative to the base member 12.

The robotic arm 10 also comprises a second member 16, which may be referred to as a lower arm or forearm 16. The second member 16 extends from the first member 14 and is coupled to the first member 14 at a second joint J2, which may also be referred to as an elbow joint. The second member 16 is movable relative to the first member 14 by a second actuator 24, which is arranged to exert a torque on the second member 16 about a second horizontal axis Z2.

At an opposite end of the second member 16, there is an end effector 18, which in the illustrated example is a gripping claw. The end effector 18 is coupled to the second member 16 via a ball joint 26 in order to allow a wide range of movement of the end effector 18.

It will be understood that, although a gripping claw is shown, the end effector 18 may be any one of a wide range of devices, including suction cups and work tools, which may be selected depending on the function which the robotic arm 10 is to carry out. Similarly, a wide range of joints other than those specifically described above may also be employed.

While a single articulated robotic arm is shown above, it will be understood that the control system described may be applicable to a wide range of different robotic arms. For example, the control system may be applied to a SCARA robotic arm or to a delta-robot arm.

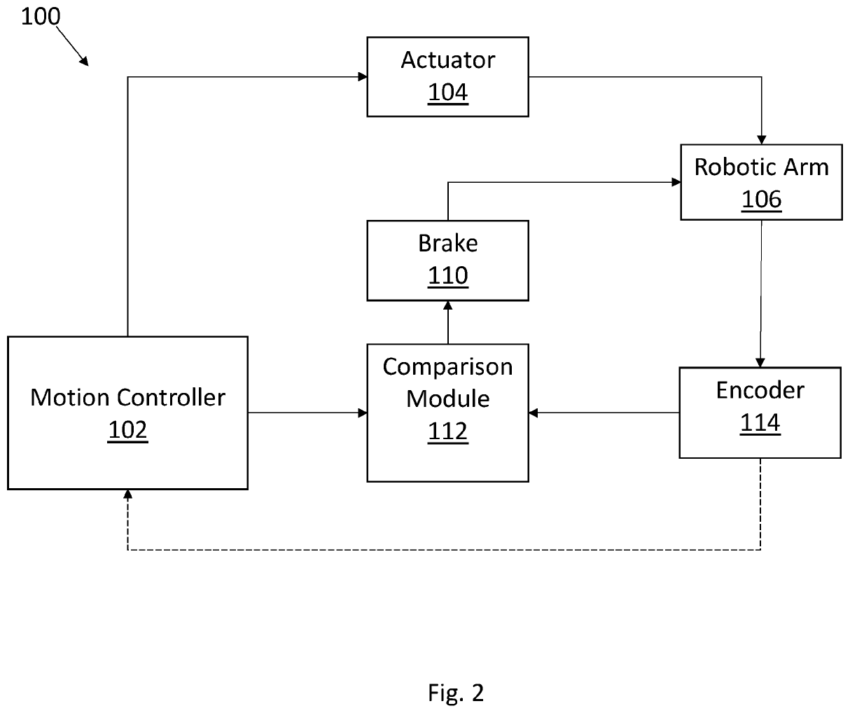

FIG. 2 shows a system diagram 100, illustrating the way in which the robotic arm may be controlled.

The system 100 comprises a motion controller 102. The motion controller 102 may be a computing system and may receive an input from a user such as a desired motion path, a location to which a robotic arm should move, or a general description of a function which the robotic arm is to carry out. The motion controller, based on estimated kinetic parameters of the robotic arm such as the mass of each member of the robotic arm, the length of each member of the robotic arm, the positions of the centres of mass of each member of the robotic arm, and the moments of inertia of the members of the robotic arm, may construct a suitable list of torque inputs for actuators to drive the robotic arm.

The motion controller 102 may also generate a series of expected robotic conditions which will be achieved based on the torques output by the actuators. The robotic conditions may comprise positions, velocities and/or accelerations of the different members of the robotic arm and/or relative positions, relative velocities and/or relative accelerations of the members of the robotic arm relative to other members of the robotic arm to which they are attached. These values may also be rotational values, since robots may have rotary joints.

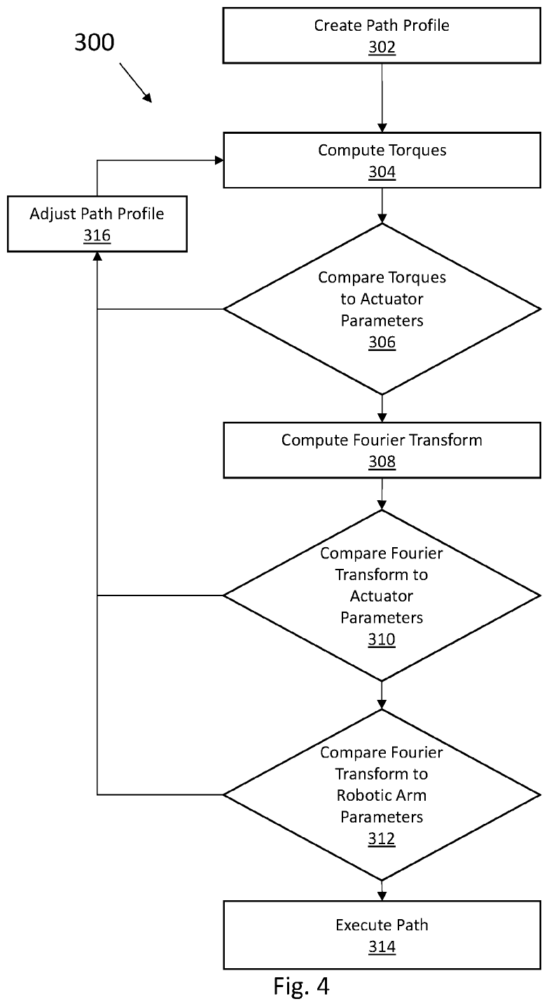

The determined torques for the actuator may be checked according to a list of parameters, such as checking that the maximum torque required by an actuator is less than 80% of the maximum torque which can be output by the actuator, ensuring that the rate of increase of the torque is within the bandwidth of the actuator, and ensuring that a highest frequency component of the torque is less than a lowest resonant frequency of the robotic arm. These parameters are explained more fully below, with reference to FIG. 4.

After the motion controller 102 has computed the desired torques, it converts these to corresponding power inputs to the actuators and supplies the power to the actuators 104. The supply may be direct or maybe via power converters or servo motors.

Simultaneously, or substantially simultaneously, the motion controller 102 may output expected robotic arm condition data to a comparison module 112. The robotic arm condition data output by the motion controller 102 to the comparison module 112 may be in substantially the same form that the comparison module 112 may receive the data from an encoder 114.

The actuator 104 is arranged to move the robotic arm 106. The actuator 104 therefore receives commands and/or power from the motion controller 102 and supplies torque to the robotic arm 106. The actuator 104 may be a plurality of actuators, such as the base, first and second actuators 20, 22, 24, shown in FIG. 1.

As the robotic arm 106 moves, the movement is measured by an encoder 114. The encoder 114 may be a linear encoder or a rotary encoder and may be an encoder assembly comprising two or more encoders at the same joint and a comparator arranged to determine whether either of the encoders is faulty, such that a reliable value can be output by the encoder 114 to the comparison module 112. An encoder 114 and/or an encoder assembly as described above may be provided at each joint of a robotic arm, such as at the base joint, first joint J1 and second joint J2 shown in FIG. 1.

The comparison module 112 compares the output of the encoder 114, which is data describing a real, measured robotic arm condition, and data from the motion controller 102, which is an expected robotic arm condition.

The comparison module 112 may be a hardware module which does not contain any memory for storing executable instructions and has a functionality which involves only the comparison of the real robotic arm condition data from the encoder 114 and the expected robotic arm condition data from the motion controller 102. The comparison module 112 may operate using analogue inputs and have no analogue to digital conversion within it.

If the comparison module 112 determines that the real robotic arm condition data and the expected robotic arm condition data differ by more than a predetermined threshold, then the comparison module 112 will generate a collision signal, which may be in the form of a power input to a brake 110 and, accordingly, the brake 110 may, based on the signal from the comparison module 112, prevent movement of the robotic arm 106. The brake 110 may be a single brake, at a base of the robotic arm as shown in FIG. 1 as the brake 20b, or may be a plurality of brakes, with one brake being located at each joint on a robotic arm.

Outside the collision detection functionality, the encoder 114 may also pass information to the motion controller 102, as indicated by the dotted line. The encoder may pass a real robotic arm condition data to the motion controller 102 for two purposes. Firstly, the encoders may provide a feedback loop in order that the motion controller can detect drift of the robotic arm away from the desired motion path and may therefore update the motion path in real time. Secondly, by providing measured robotic arm condition information to the motion controller 102, the motion controller 102 may be able to update the robotic arm kinetic parameters such that the expected robotic arm condition can be determined more accurately in future. In this way, the control system 100 may carry out a learning algorithm.

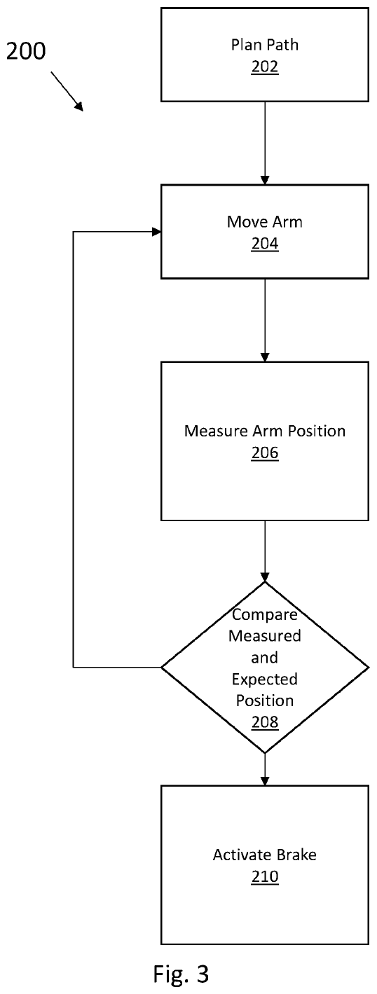

FIG. 3 is a flowchart illustrating a method 200 by which the above control system 100 may operate. At step 202, the motion controller 102, plans a path for the robotic arm to carry out. By driving the actuators 104, the robotic arm is then moved at step 204.

During the movement, the encoders 114 measure the arm position at step 206.

The measured position is then output to the comparison module 112, which compares the measured and expected position at step 208. If the measured and expected positions are the same or differ by less than a predetermined threshold, then the arm will continue to move at step 204 and the process will be repeated until the path has been completed. Otherwise, if the measured and expected positions differ by a value greater than the predetermined threshold, then movement is ceased, and the brake 110 will be activated at step 210.

While the above method is described with reference only to arm position, it will be understood that position, velocity, and/or acceleration may all be measured, determined, expected and compared as components of a robotic arm condition.

FIG. 4 is a flowchart showing a method 300 for creating a path profile suitable for use with the above-described collision detection method. The overall purpose of the method 300 is to create a motion pathway robotic arm having generally predictable movement so that collisions can be more easily detected. It is therefore noted that this method of path creation may be applicable to a wide range of collision detection methods, beyond those described in this specification.

Firstly, a path profile is created. This may be performed by a computer or may be input to a computer by a human at step 302. A motion controller then determines what torques are necessary for carrying out the required movement at step 304. Subsequently, at step 306, the computed torques are compared to parameters of the actuator. For example, the maximum computed torque is compared to the maximum torque which the actuator is able to output. More specifically, the comparison may be made between the maximum computed torque, and 80% of the maximum torque which the actuator can output. If the maximum computed torque is deemed to be excessive, then the path profile is adjusted at step 316, such as by altering the path to reduce acceleration of the arm, and the torques are recomputed.

By keeping the computed torques below the maximum torque of the actuator, optionally below 80% of the maximum torque of the actuator, it may be ensured that the actuator will operate more predictably, as actuators may have unpredictable correlations between the power input to them and the torque generated when they are operated near the maximum torque capacity.

If the torques are within an acceptable range, then a Fourier transform of the computed torques is calculated at step 308. By calculating a Fourier transform, the frequency components of the required torque profile may be generated and can subsequently been used in comparison steps.

The Fourier transform of the computed torques can be compared to actuator parameters at step 310. For instance, it can be ensured that the current computed torque does not increase at a rate in excess of the bandwidth of the actuator. Since actuators have a capacitance and a mass, actuators are not able to accelerate quickly beyond a known acceleration. In particular, actuators may behave unpredictably when faced with torque requirements which have high rates of change.

If, at step 310, it is determined that the computed torques have a rate of change outside the bandwidth of the actuator, then the path profile can be adjusted at step 316 and the method repeated. If, however, the rates of change of the torques are within the bandwidth of the actuator, then the method may move to step 312.

At step 312, the Fourier transform of the computed torques is compared to parameters of the robotic arm. These parameters may be kinetic parameters, such as a resonant frequency of the robotic arm. By comparing the Fourier transform to the resonant frequency of robotic arm, it can be ensured that the robotic arm will not undergo resonance during the movement. Resonance may be misconstrued by a comparison module as a collision and is therefore undesirable.

If it is determined that the frequency of the computed torques is close to or the same as a resonant frequency of the robotic arm, then the path profile may be adjusted at step 316. Otherwise, the path may be deemed acceptable and may be executed subsequently at step 314.

The above disclosure is given by way of example only and is not intended to limit the scope of the invention. The scope of the invention is limited only by the appended claims.

1. A method of monitoring movement of a robotic arm, the robotic arm being arranged to be moved by an actuator, the method comprising:
determining an expected robotic arm condition based on a known robotic condition and a torque applied to the robotic arm by the actuator;
measuring an actual robotic arm condition during movement of the arm caused by the applied torque; and
determining whether a collision has occurred by comparing the actual robotic arm condition with the expected robotic arm condition and generating a collision signal if a difference between the actual robotic arm condition and the expected robotic arm condition exceeds a threshold.

2. The method of claim 1, wherein the comparing is carried out by a hardware module.

3. The method of claim 1, further comprising stopping motion of the robotic arm based on the collision signal.

4. The method of claim 3, wherein the stopping comprises activating a brake.

5. The method of claim 1, wherein the robotic arm condition comprises at least one of:
a position of the robotic arm,
a velocity of the robotic arm, and
an acceleration of the robotic arm.

6. The method of claim 5, wherein the position, velocity and/or acceleration are angular position, angular velocity and/or angular acceleration respectively.

7. The method of claim 6, wherein the measuring is performed by an encoder assembly on the robotic arm.

8. The method of claim 7, wherein the encoder assembly comprises two encoders arranged to output data to an encoder comparator and wherein the encoder comparator is arranged to determine a difference between the outputs of the encoders.

9. The method of claim 1, further comprising:
picking up a load with the robotic arm;
wherein the threshold is based at least partially on the mass of the load.

10. The method of claim 9, further comprising:
modifying the threshold subsequently to the picking up of the load.

11. The method of claim 1, further comprising estimating the torque based on an electrical current input to the actuator.

12. The method of claim 1, wherein the estimated torque is less than 80% of the maximum torque of the actuator.

13. The method of claim 1, further comprising calculating a Fourier transform of the applied torque before the movement of the robotic arm and selecting the applied torque based on the Fourier transform.

14. The method of claim 1, wherein a rate of change of the applied torque is within the bandwidth of the actuator.

15. The method of claim 1, wherein a highest frequency component of the applied torque has a lower frequency than the lowest resonant frequency of the robotic arm.

16. The method of claim 1, wherein the robotic arm comprises a plurality of joints, each joint having at least one actuator, and wherein the measuring comprises measuring a relative position, a relative velocity and/or a relative acceleration for each joint.

17. The method of claim 1, wherein the determining the expected robotic arm condition is based at least partially on estimated robotic arm kinetic parameters, and
wherein the method further comprises estimating the robotic arm kinetic parameters based on an actual robotic arm condition measured during movement of the robotic arm by the actuator.

18. A robotic arm comprising:
a first member,
a second member moveably coupled to the first member,
an actuator arranged to move the first member relative to the second member,
a measuring device for determining a condition of the first and/or second member, and
a controller coupled to the actuator and measuring device arranged to carry out the method of any preceding claim.

19. The robotic arm of claim 18, wherein the controller comprises:
a motion controller arranged to determine the expected robotic arm condition; and
a separate comparison module arranged to compare the expected robotic arm condition to the measured robotic arm condition.

20. The robotic arm of claim 19, further comprising a brake arranged to prevent movement of the first and/or second member selectively, wherein the comparison module is arranged to drive the brake directly.
